(19) United States
(12) Patent Application Publication
(10) Pub. No.: US 2023/0275751 A1
(43) Pub. Date: Aug. 31, 2023

(54) Decentralized Cryptography

(71) Applicant: Workgraph, Inc., San Francisco, CA (US)

(72) Inventors: David Sneider, San Francisco, CA (US); Christopher Cassano, San Francisco, CA (US)

(73) Assignee: Workgraph, Inc., San Francisco, CA (US)

(21) Appl. No.: 17/813,478

(22) Filed: Jul. 19, 2022

Related U.S. Application Data
(60) Provisional application No. 63/203,350, filed on Jul. 19, 2021.

(51) Int. Cl. H04L 9/08; H04L 9/32

(52) U.S. Cl. CPC H04L 9/085; H04L 9/0819; H04L 9/3247; H04L 9/3297; H04L 9/3242

(57) ABSTRACT

The present invention relates to a method and system for decentralized cryptography and encryption on a network of decentralized nodes. The invention further relates to creation of private network key shares by multiple nodes on the network and receiving requests from the network to use the private network key shares. The invention further relates to performing operations with the private network key shares, wherein the operation produces a result that is provided to the network.

### CROSS REFERENCE TO RELATED APPLICATIONS

This application claims the benefit of U.S. Provisional Patent Application No. 63/203,350, filed on Jul. 19, 2021, entitled “Decentralized Access Control Infrastructure,” which is hereby incorporated by reference in its entirety.

### FEDERALLY SPONSORED RESEARCH OR DEVELOPMENT

None.

### TECHNICAL FIELD

The present invention relates to systems and methods for decentralized cryptography. The invention further relates to an encryption service that can store distributed encryption keys on networks and that provides for storing and retrieving encrypted cryptographic keys subject to limited access conditions.

### BACKGROUND

Decentralization has two core benefits to the people and entities that make up society. The first is the motivation behind Bitcoin, to be an alternative to fiat currency. The second is the motivation behind Ethereum, to be the decentralized ‘world computer’ that can transform industries and behavior.

This world computer is still in its infancy, as evidenced by the application developers, brands, creators, and communities who face challenges on how to best serve their stakeholders using the world computer. The reason they face this challenge is that today, the ‘world computer’ is missing a vital component, a blockchain based access-control list (“ACL”) mechanism for private data and access control. In computer security, an ACL is a list of permissions associated with a resource. As a result, most attempts at building consumer ready applications result in vanity benefits such as being able to be the ‘owner’ of an NFT despite that the NFT owned is a .jpeg that is downloadable by everyone.

There is a need for a decentralized web utility to grant access to data, experiences, content, platforms, and any other resource based on any on-chain state data.

The decentralized web is open and public by default and design. To add permissions and privacy to the decentralized web, encryption is required. There is a need for an encryption service that can store permissions and encrypted resources on public networks that can only be decrypted based on selected on-chain conditions.

There is also further a need for a decentralized utility that uses encryption to provide blockchain users access to digital and real world experiences, such as to encrypt and lock static content (images, videos, music, etc) behind an on chain condition (for example, possession of an NFT), decrypt static content locked behind an on chain condition, authorize network signatures that provide access to dynamic content (for example, a server or network resource) behind an on chain condition, and request a network signed JWT that provisions access and authorization to dynamic content behind an on chain condition.

Decentralization aims to unwind the unsavory consequence of consolidating and centralizing power. Individuals can claim and hold more power through data self-sovereignty. There is a need for an internet designed to support user-owned platforms that properly compensates creators and service providers while providing individuals privacy.

### SUMMARY

The present invention provides decentralized cryptography and access control for the composable and ownable internet. With the discovery of blockchains, the internet has entered an era where individuals are reclaiming power by traveling around the web with their digital private property. The invention helps creators in this new internet build connected experiences simply, without sacrificing privacy or sovereignty.

The invention provides a decentralized network for cryptography and access control enabling customized experiences and decentralized networks interoperability without centralized intermediaries. The invention allows blockchain, dApp, NFT, and web2 teams to build blockchain data bridges, DAO tooling, crypto community engagement, targeted airdrops, interactive NFTs, and more. The invention can be used to gate embedded videos and livestreams.

The invention provides a decentralized utility that uses encryption to provide blockchain users access to digital and real-world experiences. The decentralized access control protocol can run on top of EVM compatible chains and Solana. The invention can harness on-chain access control conditions to do the following things: encrypt and lock static content (images, videos, music, etc) behind an on chain condition (for example, possession of an NFT); decrypt static content that was locked behind an on chain condition; authorize network signatures that provide access to dynamic content (for example, a server or network resource) behind an on chain condition; and, request a network signed JWT that provisions access and authorization to dynamic content behind an on chain condition.

With this functionality, the invention can enable the creation of locked NFTs that can only be unlocked by owners of that NFT. It also enables provisioning access to a given server or network resource only to NFT owners. Rather than a simple JPEG, the invention enabled NFTs can be HTML/JS/CSS web pages that can be interactive and dynamic.

### BRIEF DESCRIPTION OF THE DRAWINGS

FIG. 1 is a block diagram of the invention.

FIGS. 2-12 are flow diagrams of multiple aspects of one embodiment of the invention.

FIG. 13 is an example access control establishment screen of one embodiment of the invention.

FIG. 14 is a schematic diagram of the invention.

Like reference numerals refer to like parts throughout the several views of the drawings.

While one or more embodiments may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but to the contrary, the disclosure is to cover all modifications, equivalents and alternatives falling within the spirit and scope of this disclosure.

### DETAILED DESCRIPTION

The invention provides decentralized access control enabling network provision of signatures and decryption keys for users that meet on-chain conditions. For web3 applications, the invention handles key management and provisioning. On-chain conditions and credentials can include, for example: user is a member of a DAO; user holds an NFT in a collection; user holds at least 0.1 ETH; the result of any smart contract function call; user owns a specific wallet address; boolean operations (AND+OR) for any of the above.

The invention provides nodes that perform distributed key generation that creates a public/private keypair, with no single entity knowing the full private key. Instead, each node only has a private key share. With this key share, nodes can do everything that they would with a normal private key, like sign and decrypt. The difference is that a user must collect these decryption or signature shares from the nodes to create the final decryption key or signature. This is known as threshold cryptography.

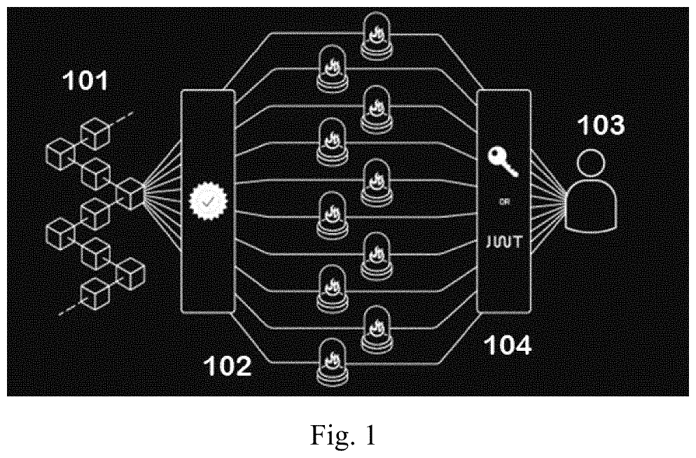

FIG. 1 shows the blockchain 101 on the left, the invention nodes 102 in the middle, and a user 103 who wants to access some resource 104 on the right. When a user 103 wants to access a resource 104 that has been protected with the invention, the user 103 signs a message with their wallet to prove they own the wallet. The user 103 uploads the signature and information about the resource 104 they want to access to all the nodes 102. Each node checks the wallet signature, checks with the blockchain 101 to make sure that the wallet meets the condition that was originally set by the person who protected the resource 104 with the invention. If the user 103 meets the condition, each node uses its private key share to either decrypt or sign, which produces a decryption share or a signature share. The user 103 collects these shares to create either a decryption key or a network signature. A user 103 can be provisioned either a decryption key or JWT (aka network signature) when they meet the on-chain conditions. These outputs provide for several technological improvements.

Encryption: The decentralized web is open and public by default and design. To add permissions and privacy to the decentralized web, encryption is required. With the encryption service provided by the invention, a user can store permissions and encrypted resources on public networks that can only be decrypted based on selected on-chain conditions. This use-case can be called “Static Content.” Some examples of resources that can be encrypted and decrypted with the invention decentralized access control: media files (images, videos, pdfs, etc); self-contained lockable HTML NFTs; dWeb document encryption (Ceramic, etc); private user data that is NOT custodied by a 3rd party; and, JWT (Network Signature). For applications that use a web3 credential (e.g. does someone hold an NFT) and want to use the credential to provision access resource that is stored on a server, applications can leverage the JWT that is provisioned to the user to grant access to the following, and more: dynamic content loaded from a server; Web2 experiences; paid access to a web2 API; user permissions within an application; and, content that receives frequent updates (i.e. a webpage with real-time price analysis).

The invention enables building web3 systems and applications including: provision an encryption key or JWT; boolean logic (“and”/“or” conditions); updatable or permanent conditions; multi-chain support; and use of preferred storage solutions.

The invention can be developed by developers via an SDK. The SDK can work in a browser and on the backend and be designed to be very easy to use.

The invention turns wallets and galleries into meta-platforms for interaction and content for asset owners, which can be viewed as their own platforms. A user can unlock an asset, sign a message with their wallet, and then access whatever content or experiences has been embedded into that asset. Additionally, the invention supports machine to machine unlocking on given qualified criteria, for example powering an SSO provider or a medical data marketplace where consumers can sell data to drug discovery companies. Finally, the invention is compatible with data and metadata storage solutions for digital assets which, when combined with locked data, enables asset ownership to function as a platform. For example, owners of assets can receive updates, notifications, exclusive content, and novel experiences via their tokens.

The invention further enables next generation NFTs. Although the invention is generalizable to many different access control use cases, locked NFTs are one application. NFTs are typically static, non-interactive media like pictures, videos, and audio files. NFTs can be dynamic, interactive, and contain locked or private data that only a token holder can view. NFTs can be as powerful as the web itself. HTML NFTs can inherit all the capabilities of a website.

Locked interactive tokens (“Lit”) have 2 states: locked and unlocked. Anyone may view a Lit in the locked state. Only token holders may unlock the Lit to see the unlocked state. The unlocking mechanism relies on a protocol that may be implemented via a JS SDK. The SDK may be embedded in the protocol so that it may unlock itself when a user clicks an unlock button.

The invention protocol enables NFTs that can be HTML files (web pages) that can be dynamic and interactive, immutable but can host dynamic content, contain an encrypted payload that only token holders can decrypt, and contain dynamic content hosted on a remote server that only token holders can access. Access control conditions are not limited to token ownership. Access can be granted to a wallet address based on any on-chain state data such as a past interaction with a given smart contract. Authentication happens via wallet signatures and RPC calls to verify that an address holds a token. In one implementation, ownership may be delegated to an ERC1155 smart contract that may run on Ethereum or any other EVM compatible network like Matic/Polygon. A Lit may be identified by an ETH token contract address and a token id. The metadata for that token may contain the IPFS address of the Lit HTML. A Lit may be backwards compatible with all existing NFTs running on EVM-based chains

The invention network may be composed of independent node operators who run a Lit Node. Running a node may require staking Lit tokens and an Intel SGX capable machine. Network users may rely on Lit Nodes for decryption and signing services. The Lit network may utilize smart contracts on an existing coordination chain like ETH or Polygon for staking, slashing, and consensus. Node responsibilities may include staking tokens as a requirement to operate a node, decentralized key generation, storage of network key shares, storage of access control conditions for private data, a p2p network with node discoverability via a DHT, a content provider DHT that stores which nodes hold which access control conditions, verification of access control conditions and providing decryption and signing services when those conditions are met (i.e. a user actually holds a token), validation of other nodes via periodic challenges, and replication of access control conditions.

A Lit protocol token may be a ‘work token’ and the tokenomics of the protocol may be designed so that the service can be provided securely and in perpetuity. For example, network participants, such as application developers, DAOs that want to maintain the Lit service, and individual users, may pay a fee to mint each Lit and stake a set amount of tokens in order for that Lit to be serviced over time (aka unlocking). The fee and staking amount may be sent in a single transaction and leverage DEX pools to make payment simple. The fee and stake amount may be determined by token holders. Nodes may stake a minimum amount of tokens to provide the service to the network. Work across the protocol may be distributed to nodes. Node rewards may be proportional to their stake. When a new Lit is created, a client may choose which nodes will receive the work based on a selection algorithm that takes into account the amount staked by the nodes, uptime, total time online, and other reputation characteristics. Additionally, the nodes may audit each other to verify they are properly providing the service. Nodes can have their stake slashed if they leave the network without following procedure or fail to perform the service.

To provide a scalable system, the invention may divide the network into subnets. Subnets may be networks of 100-300 nodes. When a subnet reaches at least 230 nodes, it may be split into 2 subnets. When a new subnet forms, its members may generate its own subnet keypair using distributed key generation. The entire network may sign this new subnet public key as a whole. This means that the subnet may inherit the security of the entire network. When a subnet signs a message for a user, the subnet may create a JWT. The JWT may include the network signature of the subnet's public key. The signature verifier can check that 1) the subnet's signature is valid, and 2) that the network signed the subnet's public key. Therefore, the verifier may only store the network public key, and be able to use it to prove that the subnet key is valid.

Epochs may occur approximately every week, based on a set number of blocks that must elapse on the coordination chain. The length of an epoch may change before the final main net launch. When a new epoch occurs, the network may split or merge subnets as needed to maintain the minimum and maximum number of nodes in a given subnet.

Following are example embodiments of the invention.

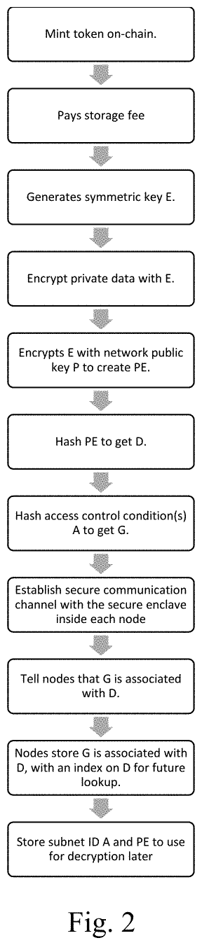

Storage. As shown in FIG. 2, a user named Alice wishes to store some private data in the Lit network. She uses the Lit JS SDK to perform the following tasks automatically, in any modern web browser. She wishes to delegate access to the data to anyone who owns a token. 1. Alice mints a token on-chain. 2. Alice pays a storage fee in the Lit ERC20 token on-chain. 3. Alice generates a symmetric key E. 4. Alice encrypts her private data with E. 5. Alice encrypts E with the network public key P to create PE. 6. Alice hashes PE to get D. 7. Alice hashes access control condition(s) A to get G. In this example, A is “the user must possess the token that Alice minted in step 1”. 8. Alice establishes a secure communication channel with the secure enclave inside each node by following the steps in “Secure enclave handshake and attestation”. 9. Alice tells the nodes that G is associated with D. 10. The nodes store that G is associated with D, with an index on D for future lookup. 11. Alice stores the subnet ID she used, A, and PE to use for decryption later, possibly inside an HTML NFT.

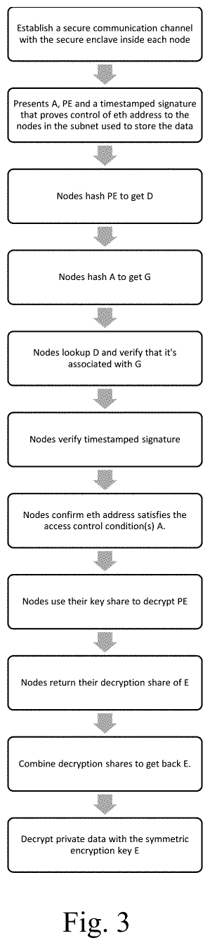

Retrieval. As shown in FIG. 3, another user, Bob, wishes to retrieve some data and meets the access control condition(s) specified by Alice. In this example, that means he possesses a token with the same tokenId and at the token contract address specified by Alice. 1. Bob establishes a secure communication channel with the secure enclave inside each node by following the steps in “Secure enclave handshake and attestation”. 2. Bob presents A, PE and a timestamped signature that proves they control their eth address to the nodes in the subnet used to store the data. 3. Nodes hash PE to get D. 4. Nodes hash A to get G. 5. Nodes lookup D and verify that it's associated with G. 6. Nodes verify Bob's timestamped signature. 7. Nodes confirm that Bob's eth address satisfies the access control condition(s) A. In this example, A is “the user must possess the token minted by Alice in step 1 of Storage”. 8. Nodes use their key share to decrypt PE. 9. Nodes return their decryption share of E. 10. Bob combines decryption shares to get back E. 11. Bob decrypts the private data with the symmetric encryption key E.

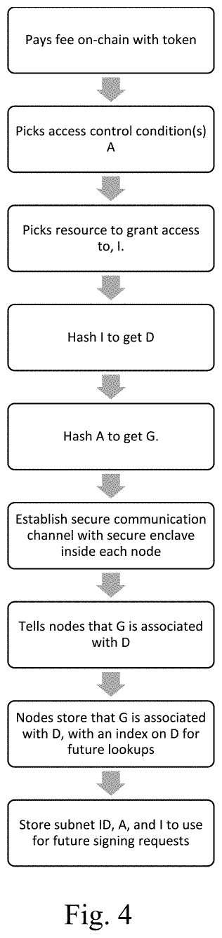

Setting access conditions for signing. As shown in FIG. 4, Alice wishes to grant access to some resource based on an access control condition, say, the possession of a token. The Lit network will then sign requests for that resource as long as the user satisfies that condition. This lets the resource or service validate access by checking that signature. 1. Alice pays a fee on-chain with the Lit ERC20 token. 2. Alice picks her access control condition(s) A. 3. Alice picks the resource that she wishes to grant access to, I. “I” could be a URL, or an anonymous SSO identity like “admin1@yearn.finance”. “I” may also contain parameters like how long a signature should be valid before it expires, or other data including a role that the user should be granted. 4. Alice hashes Ito get D. 5. Alice hashes A to get G. 6. Alice establishes a secure communication channel with the secure enclave inside each node by following the steps in “Secure enclave handshake and attestation”. 7. Alice tells the nodes that G is associated with D. 8. The nodes store that G is associated with D, with an index on D for future lookups. 9. Alice stores the subnet ID she used, A, and Ito use for future signing requests.

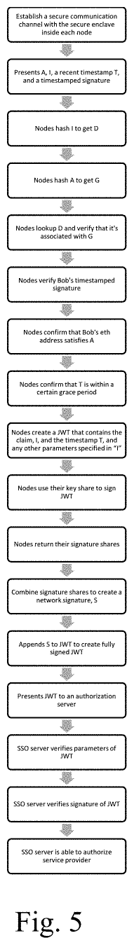

Requesting network signature. As shown in FIG. 5, Bob wishes to access a resource I and meets the access control condition(s) specified by Alice. In this example, that means he possesses a token with the same tokenId and at the token contract address specified by Alice. 1. Bob establishes a secure communication channel with the secure enclave inside each node by following the steps in “Secure enclave handshake and attestation”. 2. Bob presents A, I, a recent timestamp T, and a timestamped signature that proves they control their eth address to the nodes in the subnet used to define access conditions. 3. Nodes hash Ito get D. 4. Nodes hash A to get G. 5. Nodes lookup D and verify that it's associated with G. 6. Nodes verify Bob's timestamped signature. 7. Nodes confirm that Bob's eth address satisfies A. 8. Nodes confirm that T is within a certain grace period (say, 5 minutes). 9. Nodes create a JWT that contains the claim, I, and the timestamp T, and any other parameters specified in “I” like the expiration of the signature or the role to be granted to Bob. 10. Nodes use their key share to sign the JWT. 11. Nodes return their signature shares to Bob. 12. Bob combines the signature shares to create a network signature, S. 13. Bob appends S to the JWT to create the fully signed JWT. 14. Bob presents the JWT to an authorization server like an SSO server. 15. The SSO server verifies the parameters of the JWT, including that the JWT is not expired. 16. The SSO server verifies the signature of the JWT against the Lit network's public key. 17. The SSO server is then able to authorize Bob to a service provider.

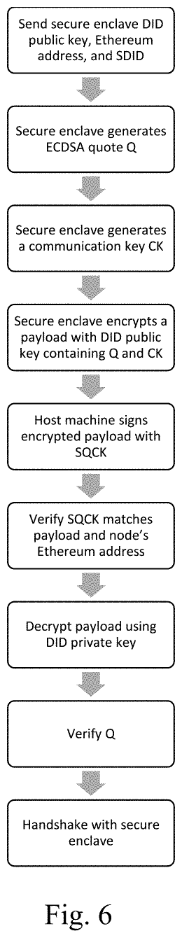

Secure enclave handshake and attestation. As shown in FIG. 6, Alice wishes to establish a secure communication channel with a secure enclave inside a given node. This process will also prove that the secure enclave is running genuine code on a genuine Intel SGX CPU. 1. Given that she has a DID public key and an Ethereum address, she sends the secure enclave her DID public key, her Ethereum address, and SDID which is a signature of her DID public key signed by her ETH address private key. The secure enclave verifies SDID and aborts if it does not match her Ethereum address. 2. The secure enclave generates an ECDSA quote Q that can be used for attestation, to show that the secure enclave is running genuine code on a genuine Intel SGX processor. 3. The secure enclave generates a communication key CK. 4. The secure enclave encrypts a payload with her DID public key. The payload contains Q and CK. 5. The host machine signs this encrypted payload with the Ethereum private key that corresponds to the Ethereum address that the node operator has used to stake Lit tokens in order to be allowed to run the node. This signature is known as SQCK. 6. She verifies that SQCK matches the payload and the node's Ethereum address. If it does not match, she aborts. 7. She decrypts the payload using her DID private key. 8. She verifies that Q is genuine by using an attestation server hosted by a different node or initially hosted centrally by the Lit devs. a. If the Q is not genuine, then she aborts communication with this specific node. b. She would then report this violation to the coordination chain smart contract, where the node operator would be penalized. 9. At this point, a handshake with the secure enclave has been completed, and she can communicate securely with the secure enclave without the host snooping or being able to modify her communications.

Node selection for storage and setting access conditions for signing. The Lit network may provide rewards, and such rewards may be in proportion to the amount staked by nodes, therefore the node selection algorithm may delegate work to nodes based on their stake. However, centralization of economic power in a handful of top nodes may be undesirable. The node selection algorithm may be designed to meet these and other goals. Note that the thresholds chosen in the current implementation are examples, and that users may choose their own thresholds, or that the protocol may have different defaults. The subnet chosen may be based on various parameters designed to evenly distribute work across the subnets.

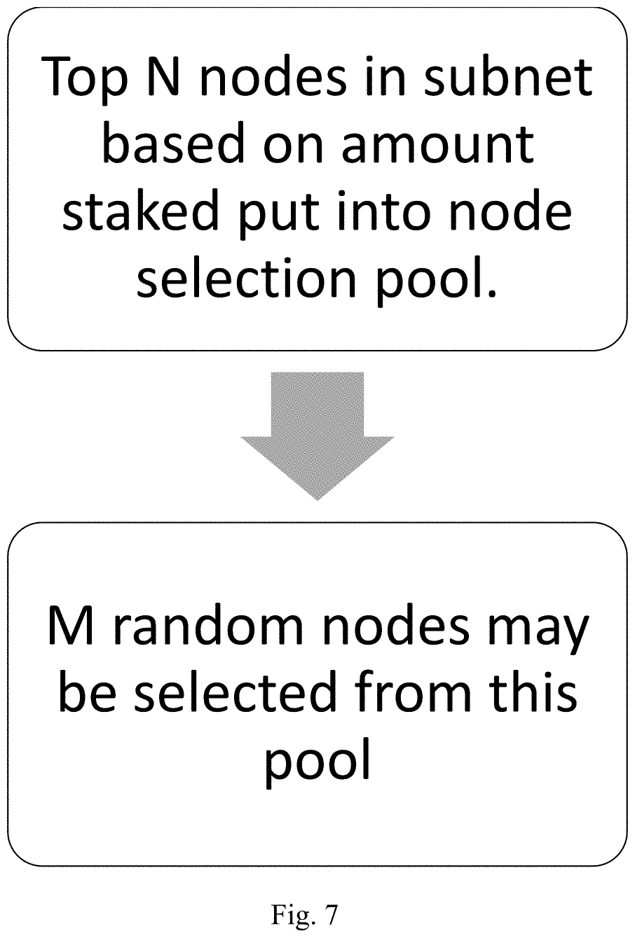

As shown in FIG. 7, selection algorithm may occur at network launch. 1. The top N nodes in the subnet based on amount staked may be put into the node selection pool. N may initially be 100 and may grow as the number of nodes increases. 2. M random nodes may be selected from this pool. M may initially be 100 but would not grow as the number of nodes increases. Therefore, in the future, the node selection pool count N may be as high as 200 nodes but only 100 random nodes may be selected each time a user wishes to store data or set access control conditions for signing.

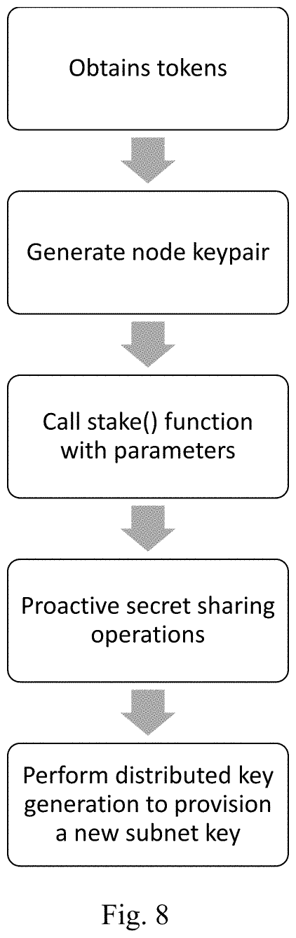

Staking. To run a node, an operator may be required to stake a given number of tokens. The minimum amount may initially be set by the network creators, but over time the market may set it based on the node selection algorithm detailed above. Node operators may stake using any Ethereum wallet, including a hardware wallet, and may delegate their stake to their node, which may have its own Ethereum address and corresponding private key. This may happen by calling the stake( ) and delegate( ) functions in the smart contract running on the coordination chain. As shown in FIG. 8: 1. Alice wishes to run a node, and she obtains enough tokens to do so. 2. She generates a node keypair. This will live on the node as a hot wallet and be used for various signing and coordination operations. 3. She calls the stake( ) function with these parameters: a. Amount of tokens to stake' b. The node keypair public key; and, c. The IP address of her node. 4. At the start of the next epoch, she will be included in the proactive secret sharing operations of the network key, and also be assigned to a subnet. 5. If the subnet is new, then she will perform distributed key generation with her fellow subnet members to provision a new subnet key. If the subnet is not new, she will be a participant in the proactive secret sharing operations of that subnet.

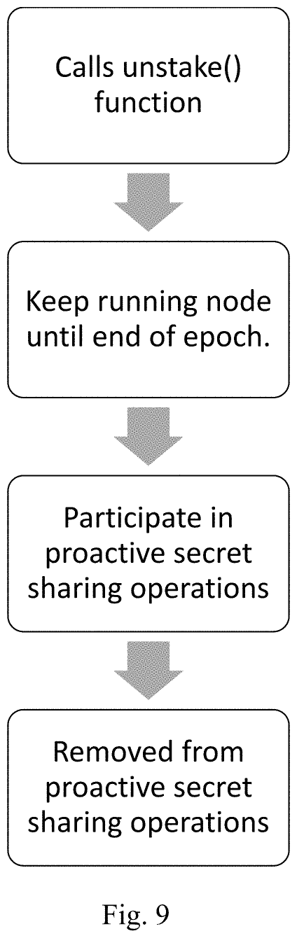

Unstaking/leaving the network. If a node operator wishes to stop running a node or leave the network, they may be required to initiate an exit process. They may indicate their intention to leave by calling a smart contract function on the coordination chain. This may give the network notice that it may need to move a node into the subnet of the exiting node, or that the network may need to merge 2 subnets in the next epoch. Going offline without completing this procedure may be a violation of the protocol and a cause for slashing. As shown in FIG. 9: 1. Alice wishes to unstake and stop running a node. 2. She calls the unstake( ) function. 3. She is required to keep running her node until the end of this epoch. This is currently set to 1 week. 4. At the start of the next epoch, she may be required to participate in the proactive secret sharing operations for the network and for her subnet, to ensure that both still have the correct threshold of nodes available to share those secrets. Ideally, this is not needed, but will depend on the number of remaining nodes in the network and subnet. If this is needed, then possibly 2 rounds of proactive secret sharing would happen: one to share the secret from the leaving nodes with the active nodes, and then another round between the active nodes, rendering her share useless. 5. She will then be removed from the proactive secret sharing operations of the network key and subnet keys.

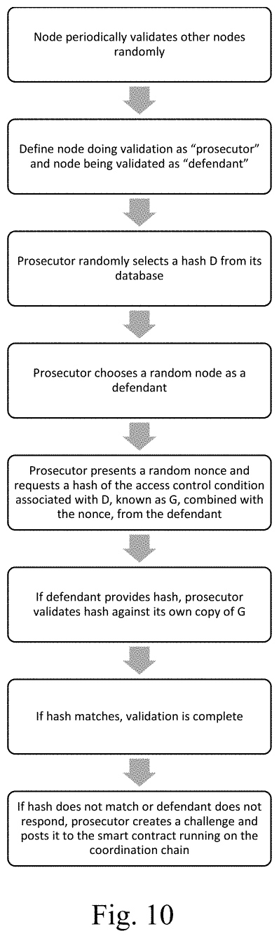

Validation and slashing. Nodes may periodically validate each other through a process detailed below. This may ensure that nodes are providing high quality service and are good actors on the network. The goal of validation may be to prove that a randomly selected node is actually storing hashes D and G, from the “Storage” and “Setting access control conditions for signing” processes. As shown in FIG. 10: 1. A given node will periodically validate other nodes randomly. This happens somewhat often, possibly 10 times per hour. 2. We shall define the node doing the validation as the “prosecutor” and the node being validated as the “defendant”. 3. The prosecutor randomly selects a hash D from its database. D could be the hash of an encryption key, or a resource that a user may be granted access to. Refer to “Storage” and “Setting access conditions for signing” for examples of D. 4. The prosecutor chooses a random node as a defendant. 5. The prosecutor presents a random nonce and requests a hash of the access control condition associated with D, known as G, combined with the nonce, from the defendant. 6. If the defendant provides the hash, the prosecutor validates the hash against its own copy of G. 7. If the hash matches, then validation is complete, and nothing else is to be done. 8. If the hash does not match, or, the defendant does not respond, then the prosecutor creates a challenge and posts it to the smart contract running on the coordination chain. 9. The challenge contains the defendant's node identifier, D, and a public key. The public key is derived from a private key which is derived by putting G through a PBKDF. In this way, the defendant will be able to prove that they hold G without revealing it. 10. If the defendant does not respond to the challenge over a period of time, say, 12 hours, then the challenge has ended and is ruled in favor of the prosecutor. The defendant has their stake slashed and the prosecutor is rewarded. 11. Alternatively, the defendant may respond to the challenge by proving that they also hold G by performing the same PBKDF on G, and signing a message with the corresponding private key. 12. The defendant presents this signed message and a corresponding public key to the smart contract running on the coordination chain to prove that they do indeed possess G. 13. If the signed message matches the public key posted by the prosecutor, then the challenge has ended, and is ruled in favor of the defendant. 14. If the signed message does not match the public key from the prosecutor, then either the prosecutor or the defendant is lying about possessing G. 15. In this case, a quorum of nodes (say, ⅔) in the same subnet may break the tie by presenting signed messages signed by the private key derived from G via the PBKDF. 16. If these messages validate with the public key from the prosecutor, then the defendant is lying, and has failed the challenge, and will be slashed. If these messages validate with the public key from the defendant, then the prosecutor is lying, and they will be slashed. If neither the prosecutor or the defendant's public keys validate with the quorum of nodes, then both the prosecutor and the defendant will be slashed. 17. Failed challenges may cause other nodes to ramp up validation of a specific node. 18. In the case of many failed challenges, a node would rapidly lose their stake.

Users of the Lit network may also be able to bring challenges to the smart contract on the coordination chain, in the case where a node has failed to decrypt or sign a request. A user created challenge may work the same as one brought by a node, since the user would possess both D and G. Users may also create a “report” in the case where a node returns data that is improperly signed, or in cases where the remote attestation of a node's Intel SGX enclave fails. In this case, it's difficult to verify the validity of the report, and that the user is not lying or griefing. Therefore, this type of report may be brought by a given threshold of users before a node is penalized. This type of report may trigger other nodes to ramp up validation of the node being reported. It may also result in the reported node being de-prioritized in the selection algorithm or removed from the selection pool temporarily, with corresponding staking rewards reduced or removed.

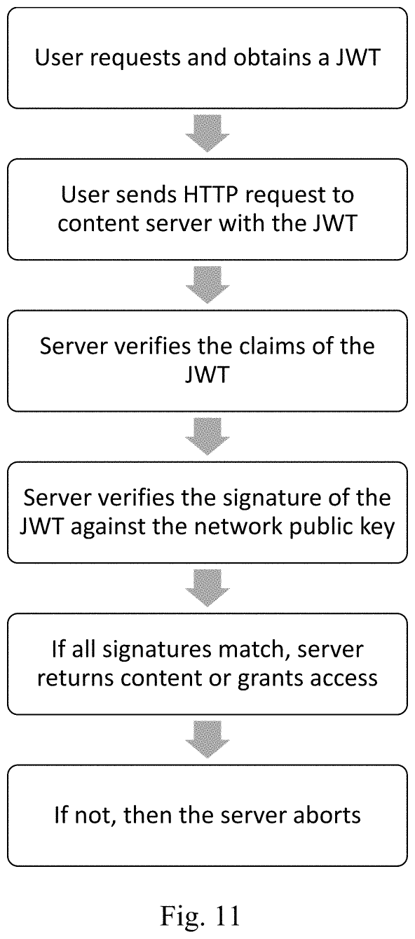

Accessing dynamic content hosted on traditional centralized servers. The Lit protocol may make it as easy as possible to verify access to a given resource. This process may require that the server validate the claims of a JWT, and the signature against the Lit network public key. As shown in FIG. 11: 1. User requests and obtains a JWT using the “Requesting network signature” process. 2. User sends HTTP request to content server with the JWT. 3. The server verifies the claims of the JWT, which include expiration time, and the resource to be granted access to. 4. The server verifies the signature of the JWT against the network public key. In the case of a subnet public key verification, the JWT will contain the subnet public key, and a signature from the network private key of the subnet public key. The server would then check both of those signatures. 5. If all the signatures match, the server returns the content or grants access. If not, then the server aborts.

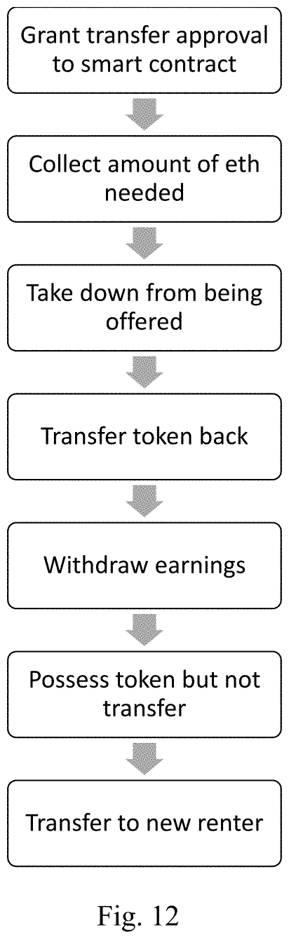

Renting. Renting may require that the underlying token contract supports the renting interface defined in the process below, and that the contract enforces the restrictions on renters like not allowing them to transfer(0) the token. Therefore, renting is not backwards compatible with existing token contracts. However, holders of tokens from existing token contracts may “wrap” their token into a new renting-compatible token contract by sending tokens to that contract. The renting protocol described below may be brought to the Ethereum community as an EIP. As shown in FIG. 12: 1. Alice wants to rent her Lit for 0.0001 ETH/second so she calls a smart contract function setForRent( ), which grants transfer approval to the smart contract. 2. Bob rents it for 600 seconds by calling a smart contract function rent( ) along with the amount of eth needed to rent it for that long, which transfers it to him and also grants itself transfer approval. 3. Bob may sub-rent it to another renter. 4. While Bob is renting, the owner can take it down from being offered for rent, and then after Bob's 600 seconds have elapsed, no one else can rent it. 5. At any time after 600 seconds, Alice can call repo( ) which will transfer the token back to her. 6. Alice can call withdraw( ) at anytime to withdraw her earnings, even while the token is being rented. 7. If Bob calls transfer( ), it will fail. Bob can possess the token but cannot transfer it. 8. Before Alice has repoed, someone else can rent it, and it's transferred from Bob to the new renter.

Security. The Lit protocol may utilize a 2-layer security system. As long as 1 of the 2 layers remains intact, the private data stored may be safe. These 2 layers are threshold encryption and trusted computing via Intel SGX.

Threshold Encryption. The Lit protocol may utilize threshold encryption and signing via the BLS signature scheme. The network may have a master keypair, and each subnet also may have a corresponding keypair. Nodes may generate the network key or subnet keys using distributed key generation techniques. This technique may allow the nodes to agree on a keypair such that no single node possesses the private key. Each node may hold a private key share, which they may use for decryption or signing of data. A client or user may combine these decryption or signing shares to fully decrypt or sign some content.

Cryptoeconomic incentives may be in place to prevent nodes from colluding. Because nodes may be staking the Lit token, they may be incentivized to be good actors and provide high quality service, and not collude. If they collude, it would undermine trust in the network and their stake would lose its value. For some use cases, the total cryptoeconomic incentivizes may be considered before storing particularly high value data.

For example, if nodes are each staking $100,000 worth of tokens, and it would take ⅔ of the 100 nodes in a subnet to collude, then one may elect to not store data worth more than $6,666,666. An example of this kind of high value data would be a wallet private key storing more than $6,666,666 in value. The true threshold may actually be higher than $6,666,666 because the colluding nodes wish to make a profit, not simply break even.

There is also the issue of whether the colluding nodes are able to establish trust that they would split the value of the stolen funds evenly, and that the first node to decrypt would not sweep the entirety of the funds into their own wallet. Additionally, the nodes may have to possess the encrypted data, and the encrypted key that can decrypt that data, referred to as PE in the processes “Storage” and “Setting access conditions for signing”. These items are publicly available. In the case of an HTML NFT that has this data embedded in it, it is publicly findable because the URL of the HTML NFT is present in the public metadata of the NFT. Where a user is storing high value data, such as a wallet private key, they may keep this data private if possible.

The Chainlink network works in a similar fashion, where if nodes colluded they could lie about an asset price to the chain and make a profit. To date, this has not happened, and it is not likely to happen on the Lit network given the cryptoeconomic incentives and coordination issues involved in this type of collusion.

Trusted computing via Intel SGX. Code running on a node may be protected with Intel SGX via remote attestation. This creates a tamper proof environment in which to process and validate data. All communication with a node is done over a secure communication channel with the secure enclave running on a node. The network private key shares are sealed by this secure enclave using an encryption key derived from the hardware and a measurement of the secure enclave code. This means a malicious enclave may not decrypt or unseal network key shares. Validation of the access control conditions A, defined in processes “Storage” and “Setting access control conditions for signing”, happens inside the enclave, preventing collusion between nodes. This validation may be performed via RPC calls to a blockchain node where the access control condition lives, for example, possession of a token on Ethereum. The RPC calls may be secured via standard HTTPS/TLS, and the certificates of the RPC servers may be verified against a CA inside the secure enclave, preventing man-in-the-middle attacks performed by the node host machine.

Lit proxy service. The invention may also provide an HTTP proxy for dynamic content providers that do not wish to implement authentication. Instead, they may pay to utilize our proxy, which will provide authentication and also obfuscate the true location of the content. This is a “no-code” solution to putting dynamic content behind the decentralized authentication infrastructure of the Lit network.

Another embodiment of the invention is a Gate NFT, which can be accessed via a link. At the link, one can claim an NFT if they satisfy the access control condition that is stored in and verified by the invention, such as owning more than a certain number of ETH or other crypto asset. The Gate NFT leverages the invention in a few ways. First, the invention can be used to gated embedded videos and livestreams. In order to watch a video, one may need to have the NFT in their wallet. Additionally, the Gate NFT is unlockable, and this function is another example of an access control condition that is stored in and verified by the invention. One can click on the NFT and unlock it to enter the gate where they can claim a social media platform such as Discord role and participate in a collaborative pixel art project with other NFT owners. The pixel art can be turned into an NFT and gifted it to a few of the Gate NFT owners.

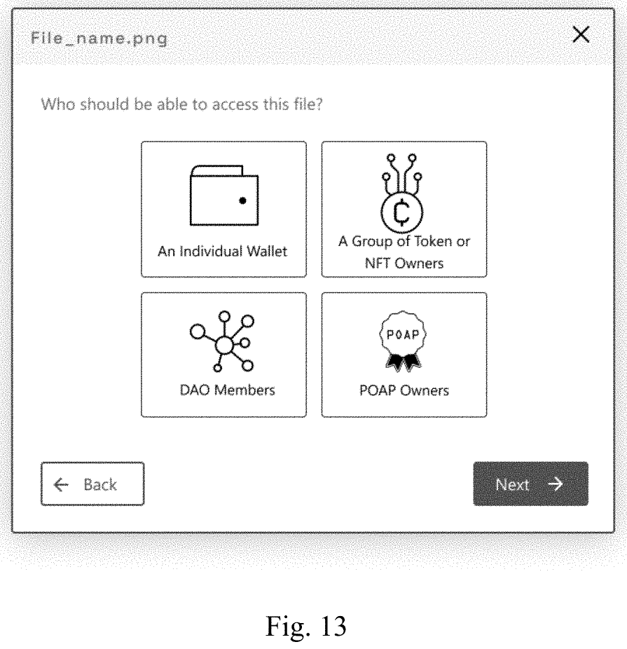

Lit Gateway. The invention Gate NFT giveaway lives on a portal to blockchain connected experiences. Through the portal one may access apps and offers. Within the apps, there may be a variety of applications that can be used with token and blockchain data gating, including cloud storage services, video conference services, and encrypted file storage. FIG. 13 shows an example access control establishment screen. Within offers, one can find for example targeted airdrops and giveaways that they can claim based on their wallet holdings and history.

Another embodiment of the invention Lit Protocol may be an open source, decentralized utility that uses encryption to provide blockchain users access to digital and real world experiences. Lit Protocol's main feature may be a decentralized access control protocol running on top of EVM chains and Solana. With Lit, a user can harness on-chain access control conditions to do 4 main things: Encrypt and lock static content (images, videos, music, etc) behind an on chain condition (for example, possession of an NFT); Decrypt static content that was locked behind an on chain condition; Authorize network signatures that provide access to dynamic content (for example, a server or network resource) behind an on chain condition; and Request a network signed JWT that provisions access and authorization to dynamic content behind an on chain condition.

With this functionality, Lit Protocol may enable the creation of locked NFTs that can only be unlocked by owners of that NFT. It also enables provisioning access to a given server or network resource only to NFT owners. Rather than a simple JPEG, Lit enabled NFTs can be HTML/JS/CSS web pages that can be interactive and dynamic.

The invention may provide the following. 1. Support many EVM chains and Solana. 2. Support many standard contracts, with plans to support any RPC call soon. 3. Boolean conditions. 4. Updateable conditions. The creator can update the condition. 5. Permanent conditions. When a condition is stored as permanent, it becomes impossible to update forever. 6. Use storage solutions including IPFS/Filecoin, Arweave, Sia, Storj, or even use centralized storage.

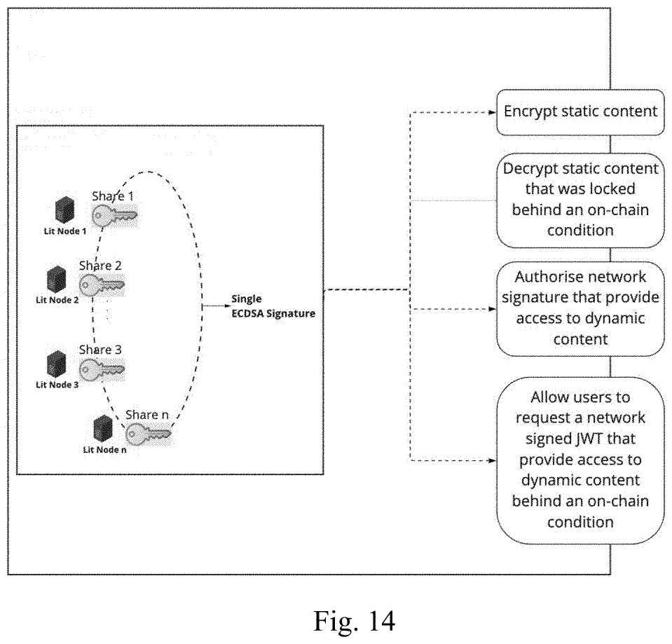

As shown in FIG. 14, the invention generates shares of public/private key pairs. Once a certain percentage of shares are confirmed by the protocol nodes, an authorized signer is able to encrypt or decrypt information.

The protocol provides the following.

Static Content—Encrypting/locking. The SDK encrypts content and uploads conditions for decryption to each Lit protocol node. A user may store the encrypted content in a place of their choosing (IPFS, Arweave, or even somewhere centralized). To access the content, the SDK may request a message signature from the user's wallet. The message signature may prove that the corresponding wallet meets the conditions (ex. NFT ownership) for decryption. The Lit protocol nodes may then send down the decryption shares. The SDK may combine them and decrypt the content.

Dynamic Content—Authorizing access to a resource via JWT. The SDK can create the authorization conditions for a given resource and store them with Lit Protocol nodes. When someone requests a network signature to access a resource (typically a server that serves some dynamic content) the SDK will request a message signature from the user's wallet. The signature allows the Lit Protocol nodes to know who owns the NFT associated with the resource. Lit Protocol nodes will verify that the user owns the NFT, sign the JWT to create a signature share, then send down that signature share. The SDK will combine the signature shares to obtain a signed JWT which is presented to the resource to authenticate and authorize the user.

The JS SDK can interact with the Lit network by performing the following.

Encrypting Static Content (images, videos, music, documents, etc). Configure Lit to grant blockchain users a symmetric encryption key when they meet certain conditions on blockchains (e.g owning an NFT, being a member of a DAO) so content can be decrypted that is stored on any decentralized or centralized storage platform.

Gate Access to Dynamic Content. Configure Lit to grant users a network signed JWT when they meet blockchain based conditions and check the validity of this token with your server.

Creating Interactive HTML NFTs. Create HTML NFTs that contain embedded HTML/JS/CSS that's only accessible to the owner of the NFT.

Installation can be achieved by for example the following. Use yarn or npm to add the lit-js-sdk to a product. The SDK may require an active connection to the Lit nodes to perform most functions (notably, a connection to the Lit nodes is not required if you are just verifying a JWT). In web apps, this is typically done on first page load and can be shared between all your pages. In NodeJS apps, this is done when when the server starts. SDK installed via yarn or the script tag (browser usage). SDK installed via yarn/NPM (NodeJS/serverside usage). SDK installed via yarn/NPM (client side usage). Listening for the lit-ready event. Debug Logging and Lit Node Client configuration.

Wallet Signatures. To use the Lit protocol, a user may present a wallet signature. This may be referred to an as AuthSig. An EIP 4361 compliant signature may be used for the authSig, but one may put the signature into the AuthSig data structure format. The Lit JS SDK may not need to be used to obtain the signature. An EIP 4361 compliant AuthSig data structure format may be used.

Obtaining the AuthSig. One may use the built in checkAndSignAuthMessage( ) function to obtain the authSig. This may trigger a wallet selection popup on the user's browser. The user may be asked to sign a message proving they own their crypto address. The message may be signed with their crypto address. The signature may be returned to you as the authSig variable. You will need to pass this to the Lit Protocol API. This function may save the AuthSig to local storage so that the user does not need to sign the message again. However, the user may be asked to sign it again if the signature has expired or is too old. This function may also check the currently selected chain in the user's wallet, and if their wallet supports it, sends a request to their wallet to change to the chain passed into the checkAndSignAuthMessage( ) function. This is to ensure that the user is using the correct chain.

Clearing the stored authSig. The authSig stored in the browser local storage may be cleared, for example by using the disconnectWeb3( ) function.

The invention also provides for error handling. For example, SDK Error Handling. Errors are thrown as exceptions when something has gone wrong. Errors are objects with a message, name, and errorCode. Possible codes are documented below.

Not Authorized. errorCode: not_authorized. Reason: Thrown when the user does not have access to decrypt or is unauthorized to receive a JWT for an item.

Wrong Network. errorCode: wrong_network. Reason: The user is on the wrong network. For example, this may mean the user has ethereum selected in their wallet but they were trying to use polygon for the current operation.

Missing access control conditions. errorCode: missing_access_control_conditions. Reason: You must pass either access_control_conditions or evm_contract_conditions or sol_rpc_conditions, and you did not pass these things to the nodes.

Incorrect access control conditions. errorCode: incorrect_access_control_conditions. Reason: The access control conditions you passed in do not match the ones that were set by the condition creator for this resourceId or encryptedSymmetricKey.

Storage error. errorCode: storage_error. Reason: An error occurred storing the condition. This usually means that you tried to update a permanent condition, or you tried to update a non-permanent condition from the wrong account. Only the creator of a condition can update it, and only if \“permanent\”: false was originally passed in when storing the condition.

Resource ID not found. errorCode: resource_id_not_found. Reason: Could not find the resource ID you passed in. You should have already called saveSigningCondition with the exact same resource ID.

Encrypted symmetric key not found. errorCode: encrypted_symmetric_key_not_found. Reason: Could not find the encrypted symmetric key you passed in. You should have already called saveEncryptionKey which returned the encrypted symmetric key.

Access control conditions check failed. errorCode: access_control_conditions_check_failed. Reason: The Lit nodes failed to check the condition. This means that the Lit nodes could not talk to the chain to check the condition. This could be because the RPC servers are down, or because the condition is making an incorrect smart contract call that reverts.

IAT outside grace period. errorCode: iat_outside_grace_period. Reason: When signing a JWT, the IAT is outside the grace period. This usually means that your system clock is wrong. Please check it and make sure it is set accurately for your timezone.

EXP wrong or too large. errorCode: exp_wrong_or_too_large. Reason: When signing a JWT, the EXP is too large or wrong. This usually means that your system clock is wrong. Please check it and make sure it is set accurately for your timezone.

Invalid Auth Signature. errorCode: invalid_auth_sig. Reason: The auth_sig passed to the nodes is invalid or could not be verified. make sure that you are passing the correct auth_sig.

Lit Node Client Not Ready Error. errorCode: lit_node_client_not_ready. Reason: The Lit node client is not ready. This means that the Lit node client is not connected to the Lit network. You should run await litNodeClient.connect( ) before calling any other methods that use the Lit Node Client.

Invalid Unified Condition Type. errorCode: invalid_unified_condition_type. Reason: In a unified access control condition, you passed an invalid conditionType.

RPC Error. errorCode: rpc_error. Reason: The Lit Node(s) could not complete the RPC call. This could be because the RPC servers are down, or because the RPC call is making an incorrect smart contract call that reverts.

Unknown error. errorCode: unknown_error. Reason: An unknown error has occurred. Please contact us on Discord to report this error.

Wallet Error Handling. Metamask and other wallets throw errors themselves.

Testing. Manual tests can run in the browser in manual_tests.html. To run these, set up a HTTP server in the build folder. One may use python for this with the built in SimpleHTTPServer module by running “python2-m SimpleHTTPServer” and then going to “http://localhost:8000/manual_tests.html” in a browser. There may also be automated tests in the tests folder but running it with nodejs may not work because this project is bundled. An attempt at bundling the tests as well is in esbuild-tests.js which may work.

### Lit Actions and PKPs

Smart contracts are powerful but generally isolated to the blockchain ecosystem on which they reside. Things like oracles and bridges help but must be set up on a case-by-case basis and are unwieldy to use. The invention may provide smart contracts that are Lit Actions and the keypairs they can use are PKPs.

PKP stands for Programmable Key Pair. Each PKP is generated collectively by the Lit Nodes through a process called Distributed Key Generation (aka DKG). This process permits the Lit Nodes to generate a new public/private keypair where nobody knows the whole private key. Instead, each node has a private key share, and they can do everything with it that they could do with a traditional private key, like sign and decrypt data. The difference is that signing with a private key share produces a signature share. These signature shares must be combined above the threshold (current ⅔ of the nodes) to produce the final signature.

Lit Actions are for example Javascript functions that can utilize the threshold cryptography that powers the Lit Protocol. One can write some JS code, upload it to IPFS, and ask the Lit Nodes to execute that code and return the result. JS functions can be used for threshold signing and decryption, so that one can ask the Lit Nodes to sign or decrypt some data with a private key share. One can collect these signature or decryption shares on the client side, and combine them to get a signature or decryption key. In the case of a signature, one can then use that signature for authentication, for example to write to a Ceramic Data stream, or to send an ETH transaction.

Lit Actions may be stored on IPFS and are immutable, like smart contracts. One can think of them as Javascript smart contracts that have network access and can make HTTP requests.

Lit Actions and PKPs work together as follows.

A user may generate a new PKP, and may grant a Lit Action the right to sign using it. This means that Lit actions are akin to smart contracts with a secret key they can use to sign or decrypt things.

One creates a PKP as follows. One mints an NFT from a PKP contract. This may be an ERC721 NFT and the owner of it is the root owner of the PKP. The NFT owner can grant the ability to use the PKP to sign and decrypt data to both other users (via their wallet address) and also to Lit Actions.

PKPs can perform the following. Since a PKP is a valid ECDSA wallet, one may send a mix of BTC and ETH NFTs to it, and then sell it as a bundle by selling the NFT that controls it, such as on OpenSea. The buyer gets the ability to sign and decrypt data with the PKP, since they own the controlling NFT. The buyer could then withdraw the BTC and NFTs if desired. This functionality securely trades a private key. This also breaks soulbound NFTs, because now one may securely trade the underlying private key that owns the soulbound tokens.

Lit Actions are decentralized serverless functions. Lit Actions may be used to sign and decrypt data with PKPs. Because Lit Actions+PKPs+web3 storage can be a replacement for a traditional web2 backend. Imagine a web3 Twitter clone that stores the data on Ceramic. One can create a PKP that owns a Ceramic stream, and then grant access to sign with that PKP to a group of Lit Actions for things like createPost( ) and likePost( ). A Lit Action can work like a web2 backend, with business logic to ensure that only correct data is written to the Ceramic Stream. For example, the likePost( ) function could check that a user has not already liked a post, and only write the like to the stream if they have not already liked it.

In web2, a backend may have god mode access to the DB. Using Lit and web3 storage like Ceramic, one can create Lit Actions that have god mode over a Ceramic stream, because the Lit Action has been granted the ability to sign with a PKP that owns the Ceramic stream. However, the Lit Action will only write to the stream according to the logic of the code inside it. This makes moving from a centralized web2 paradigm to a decentralized web3 paradigm much easier.

The network consensus performs as follows. Because nodes each hold a private key share, and for example ⅔ are required to sign or decrypt with their private key share, any signature or decryption key generated by the Lit Network may be required to have been approved by at least ⅔ of the nodes. Lit Protocol may not have a traditional consensus mechanism like most blockchains. This threshold is mathematically enforced by the threshold cryptography Lit uses.

To create a Lit Action, one may write some Javascript code that will accomplish the goals. The Lit Protocol provides JS function bindings to provide for example request a signature or a decryption. One may also need client side JS to collect responses from the Lit Nodes and combine them above the threshold into a signature or decrypted data.

One may use Lit to encrypt and store any static content, such as a file, a string, or anything that will not change. One may have to store the content and metadata themselves, such as on IPFS, Arweave, or somewhere centralized. The Lit protocol may store who is allowed to decrypt it and enforce this such as by key management.

Authing Dynamic Content via JWT (content loaded from a server). Verifying a JWT that was signed by the Lit network. Verifying a JWT may be done on the server side (nodej s), but may work in a browser too. One may be required to have a JWT to verify. This may come from the user who is trying to access the resource. One may try the JWT hardcoded. One may use a JWT presented by the user.

The “verified” variable is a boolean that indicates whether or not the signature verified properly. One may need to look at “payload.baseUrl” which ay match the hostname of the server, and one may also look at “payload.path” which may match the path being accessed. If these do not match what one is expecting, they may reject the request.

Provisioning access to a resource. Use dynamic content provisoning to put some dynamic content behind an on chain condition (for example, possession of an NFT). This function will store that condition and the resource that users who meet that condition should be authorized to access. The resource could be a URL, for example. The dynamic content server should then verify the JWT provided by the network on every request, which proves that the user meets the on chain condition.

HTML NFTs. HTML NFTs are super-powered NFTs. To mint an HTML NFT, one may mint (or already own) any ERC721 or ERC1155 NFT that will serve as the access control token for unlocking the NFT. Pre-deployed ERC1155 NFT contracts may, for example, be provided on Polygon and Ethereum.

Once one has a NFT, they may lock and associate content with it on the Lit network. In an implementation in MintLit, one may render the locked content as an HTML string, embedding any media such as pictures or videos as data urls. One may do this, or encrypt files directly without rendering them into a HTML string.

One may need to encrypt the symmetric key, and save it to the Lit nodes. One may also define access control conditions, which are the conditions under which someone can decrypt the content. One may store token metadata so that the HTML NFT is backwards compatible with existing NFT websites. One may use Firebase for this.

To unlock a HTML NFT, one may retrieve the encryption key shares from the nodes. This SDK may provide a convenience function to do this that may pull down the encryption key shares and combine them into the encryption key itself, decrypt content and then load the content into a div. One may implement this as follows. First, obtain an authSig from the user that asks their metamask to sign a message proving they own the crypto address that presumably owns the NFT. Pass the chain you're using. Next, obtain the symmetric key from the Lit network. Finally, decrypt the content and inject it into the webpage. A convenience function may be provided to unlock the Lit with the symmetric encryption key.

Ceramic Integration. A simple web application encrypting and decrypting a string using Lit's Ceramic SDK may be achieved with the invention. Ceramic is doesn't have permission on data. Everything is public. With Lit protocol, one can specify who can decrypt and therefore read data based on on-chain conditions. This module allows one to integrate Ceramic with Lit.

As an example, one may build a website for a social DAO that throws member-only events. Members are people who hold the NFT for the DAO. Using Ceramic as the database and Lit for encrypting and decrypting events information, one can specify that only DAO members can see the events. One can use Lit to encrypt the events data, then store that encrypted data in Ceramic. When one wants to access that information—one can use Lit to check access control conditions (in this case, NFT ownership) and decrypt the data from Ceramic.

The invention thus provides a decentralized fully serverless database solution to share private data. Ceramic is a decentralized serverless database but does not share private data. The invention allows for sharing private data on Ceramic to specify who can decrypt the data.

Share Modal. The invention may provide a Lit Share Modal tool for creating access control conditions for securing content with Lit Protocol that: secures content based on wallet address, token/NFT holdings, POAP ownership, or DAO membership; creates multiple paths for unlocking content by using AND/OR operators; and, sets most used tokens/NFTs as defaults for quick and easy access.

All publications and patent documents cited in this application are incorporated by reference in pertinent part for all purposes to the same extent as if each individual publication or patent document were so individually denoted. By citation of various references in this document, Applicants do not admit any particular reference is “prior art” to their invention. It is to be appreciated that the foregoing Detailed Description section, and not the Abstract section, is intended to be used to interpret the claims. The Abstract section may set forth one or more, but not all, exemplary embodiments of the present invention as contemplated by the inventor(s), and thus, is not intended to limit the present invention and the appended claims in any way.

The foregoing description of the specific embodiments should fully reveal the general nature of the invention so that others can, by applying knowledge within the skill of the art, readily modify and/or adapt for various applications such specific embodiments, without undue experimentation, without departing from the general concept of the present invention.

Moreover, the breadth and scope of the present invention should not be limited by any of the above-described exemplary and illustrative embodiments but should be defined only in accordance with the below claims and their equivalents.

Because many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents. From the foregoing, it will be seen that this application is one well adapted to attain all the ends and objects hereinabove set forth together with other advantages which are obvious, and which are inherent to the structure.

It will be understood that certain features and sub-combinations are of utility and may be employed without reference to other features and sub-combinations. This is contemplated by and is within the scope of the claims.

While various embodiments have been described and illustrated herein, one will readily envision a variety of other means and/or structures for performing the function and/or obtaining the results and/or one or more of the advantages described herein, and each of such variations and/or modifications is deemed to be within the scope of the embodiments described herein. More generally, one will readily appreciate that all parameters, dimensions, materials, and configurations described herein are meant to be exemplary and that the actual parameters, dimensions, materials, and/or configurations will depend upon the specific application or applications for which the teachings is/are used. One will recognize or be able to ascertain using no more than routine experimentation, many equivalents to the specific embodiments described herein. It is, therefore, to be understood that the foregoing embodiments are presented by way of example only and that, within the scope of the disclosure, including the appended claims and equivalents thereto, disclosed embodiments may be practiced otherwise than as specifically described and claimed. Embodiments of the present disclosure are directed to each individual feature, system, tool, element, component, and/or method described herein. In addition, any combination of two or more such features, systems, articles, elements, components, and/or methods, if such features, systems, articles, elements, components, and/or methods are not mutually inconsistent, is included within the scope of the present disclosure.

The above-described embodiments can be implemented in any of numerous ways. For example, embodiments may be implemented using hardware, software or a combination thereof. When implemented in software, the software code can be stored (e.g., on non-transitory memory) and executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, netbook computer, or a tablet computer. Additionally, a computer may be embedded in a device not generally regarded as a computer but with suitable processing capabilities, including a smart phone, smart device, or any other suitable portable or fixed electronic device.

Also, a computer can have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer can receive input information through speech recognition or in other audible format.

Such computers can be interconnected by one or more networks in any suitable form, including a local area network or a wide area network, such as an enterprise network, and intelligent network (IN) or the Internet. Such networks can be based on any suitable technology and can operate according to any suitable protocol and can include wireless networks, wired networks or fiber optic networks.

The various methods or processes outlined herein can be coded as software that is executable on one or more processors that employ any one of a variety of operating systems or platforms. Additionally, such software can be written using any of a number of suitable programming languages and/or programming or scripting tools, and also can be compiled as executable machine language code or intermediate code that is executed on a framework or virtual machine.

In this respect, various disclosed concepts can be embodied as a computer readable storage medium or multiple computer readable storage media (e.g., a computer memory) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” are used herein in a generic sense to refer to any type of computer code or set of computer-executable instructions that can be employed to program a computer or other processor to implement various aspects of embodiments as discussed above. One or more computer programs that when executed perform methods of the present disclosure need not reside on a single computer or processor but can be distributed amongst a number of different computers or processors to implement various aspects of the disclosure.

Computer-executable instructions can be in many forms, such as program modules, executed by one or more computers or other devices. Generally, program modules include routines, programs, objects, components, data structures, etc. that perform particular tasks or implement particular abstract data types. Typically, the functionality of the program modules can be combined or distributed as desired in various embodiments.

Also, data structures can be stored in computer-readable media in any suitable form. For simplicity of illustration, data structures may be shown to have fields that are related through location in the data structure. Such relationships can likewise be achieved by assigning storage for the fields with locations in a computer-readable medium that convey relationships between the fields. However, any suitable mechanism can be used to establish a relationship between information in fields of a data structure, including through the use of pointers, tags or other mechanisms that establish relationships between data elements.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), or other types of mobile devices. The mobile devices can communicate wirelessly (for example, using radio frequency (RF) signals) to various communication networks (described below).

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

Also, various concepts can be embodied as one or more methods, of which an example has been provided. The acts performed as part of the method may be ordered in any suitable way. Accordingly, embodiments can be constructed in which acts are performed in an order different than illustrated, which can include performing some acts simultaneously, even though shown as sequential acts in illustrative embodiments. All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of” “Consisting essentially of,” when used in claims, shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for decentralized cryptography and encryption comprising:
accessing a network of decentralized nodes;
receiving a request from the network to create a share of a private network key;
creating a share of a private network key in response to the request, wherein another node on the network has another share of the private network key;
receiving a request from the network to use the private network key share;
performing an operation with the private network key share, wherein the operation produces a result; and,
providing the result of the operation performed with the private network key share to the network.

2. The method of claim 1 further comprising:
receiving a request from a user of the network to create a signature share of the private network key share;
creating a signature share of the private network key share; and,
providing the signature share to the user over the network.

3. The method of claim 2 further comprising:
receiving with the request access control conditions for the private network key; and
verifying the access control conditions are met before creating the signature share.

4. The method of claim 1 further comprising:
receiving a request from a user of the network to create a decryption share of the private network key share; and,
creating a decryption share of the private network key share; and,
providing the decryption share to the user over the network.

5. The method of claim 4 further comprising:
receiving with the request access control conditions for the private network key; and
verifying the access control conditions are met before creating the decryption share.

6. The method of claim 1 wherein the request comprises executable code and further comprising executing the code to define the use of the private network key share.

7. The method of claim 6 wherein the use of the private network key share comprises creating a signature share of the private network key share.

8. The method of claim 6 wherein the use of the private network key share comprises creating a decryption share of the private network key share.

9. A method for storing and retrieving an encrypted cryptographic key subject to limited access conditions comprising:
storing an encrypted cryptographic key, wherein storing comprises:
generating a symmetric key,
encrypting the symmetric key with a network public key,
hashing the encrypted symmetric key,
hashing access control conditions data;
establishing secure communication channel with a secure enclave inside a node in the network;
communicating to nodes that hashed access control conditions data is associated with hashed encrypted symmetric key; and,
storing the hashed access control conditions data associated with the hashed encrypted symmetric key with an index on the hashed encrypted symmetric key;
retrieving the encrypted cryptographic key, wherein retrieving comprises:
establishing secure communication channel with a secure enclave inside a node in the network;
presenting encrypted symmetric key and a timestamped signature proving control of blockchain address to nodes in a subnet storing the cryptographic key;
hashing the encrypted symmetric key;
verifying timestamped signature;
confirming network address satisfies access control condition;
decrypting encrypted symmetric key with key share;
returning decrypted share of symmetric key;
combining decryption shares to produce symmetric key; and,
decrypting encrypted cryptographic data with symmetric key.

10. The method of claim 9 further comprising:
setting the access control conditions, wherein setting comprises:
selecting access control conditions;
selecting encrypted cryptographic key to be subj ect of control conditions;
hashing encrypted cryptographic key;
hashing access control conditions;
establishing secure communication channel with a secure enclave inside a node in the network;
telling node that hashed access control conditions is associated with hashed encrypted cryptographic key;
communicating to the network that hashed access control conditions are associated with hashed encrypted cryptographic key; and,
storing encrypted cryptographic key.

11. The method of claim 10 wherein the access control conditions is that a user holds a specified token.

12. The method of claim 11 wherein the token is a non-fungible token.

13. The method of claim 9 wherein the network is a blockchain,

14. The method of claim 10 wherein the network is a blockchain.

15. A computing system for cryptography and encryption comprising:
a computing node comprising memory and a processor,
a component configured to accesses a network of decentralized nodes;
a component configured to receive a request from the network to create a share of a private network key;
a component configured to create a share of a private network key in response to the request, wherein another node on the network has another share of the private network key;
a component configured to receive a request from the network to use the private network key share;
a component configured to perform an operation with the private network key share, wherein the operation produces a result; and,
a component configured to provide the result of the operation performed with the private network key share to the network.

16. The computing system of claim 15 further comprising:
a component configured to receive a request from a user of the network to create a signature share of the private network key share;
a component configured to create a signature share of the private network key share; and,
a component configured to provide the signature share to the user over the network.

17. The computing system of claim 16 further comprising:
a component configured to receive with the request access control conditions for the private network key; and
a component configured to verify the access control conditions are met before creating the signature share.

18. The computing system of claim 15 further comprising:
a component configured to receive a request from a user of the network to create a decryption share of the private network key share;
a component configured to create a decryption share of the private network key share; and,
a component configured to provide the decryption share to the user over the network.

19. The computing system of claim 18 further comprising:
a component configured to receive with the request access control conditions for the private network key; and
a component configured to verify the access control conditions are met before creating the decryption share.

20. The computing system of claim 15 wherein the request comprises executable code further comprising a component to execute the code to define the use of the private network key share.
